(19) United States
(12) Patent Application Publication
(10) Pub. No.: US 2010/0108601 A1
(43) Pub. Date: May 6, 2010

(54) Method for Treating Ballast Water with a Membrane

(76) Inventors: Masahiro Saito, Tokyo (JP); Shunsuke Yamazaki, Tokyo (JP); Masafumi Matsumoto, Tokyo (JP); Toshio Sano, Tokyo (JP)

Correspondence Address: CROCKETT & CROCKETT, P.C., 26020 ACERO, SUITE 200, MISSION VIEJO, CA, 92691, US

(21) Appl. No.: 12/593,101

(22) PCT Filed: Mar. 19, 2008
(86) PCT No.: PCT/JP2008/055101

§ 371 Date: Sep. 25, 2009

(30) Foreign Application Priority Data
Mar. 30, 2007 (JP) 2007-095698

(51) Int. Cl. B01D 65/08

(52) U.S. Cl. 210/636

(57) ABSTRACT

To provide a method for treating ballast water with a membrane, which can reliably remove a fouling substance derived from a gel-like substance and a fouling substance of mineral origin, the fouling substances attached to a membrane, by separating or breaking down the fouling substances, and can maintain the membrane flux for long periods.

In a method for treating ballast water with a membrane, the method provided with, in or on a hull of a ship, the membrane treatment equipment 1 that separates a microorganism with a size equal to or greater than a predetermined size, a fouling substance attached to the surface of the membrane is dissolved, broken down, or removed by using a cleaning fluid containing a peroxide which is at least one selected from hydrogen peroxide, hypochlorous acid, and ozone water.

### TECHNICAL FIELD

The present invention relates to a method for treating ballast water with a membrane, and more particularly to a method for treating ballast water with a membrane, which can reliably separate fouling substances (a mineral and a gel-like substance) attached to a membrane and maintain the membrane flux for long periods.

### BACKGROUND ART

A cargo ship transporting crude oil or the like has ballast tanks for maintaining the stability of a hull during navigation. Usually, the ballast tanks are filled with ballast water when the ship is not loaded with crude oil or the like, and the ballast water is discharged when crude oil or the like is loaded into the ship. In this way, the buoyancy of the hull is adjusted to stabilize the hull. As described above, the ballast water is water required for safe navigation of the ship, and normally seawater at a port where cargo handling is carried out is used. The amount thereof is estimated to be over 10 billion tons per year on a worldwide basis.

Incidentally, the ballast water contains microorganisms or eggs of small and large organisms, which inhabit a port where the ballast water was taken in. As the ship moves, such microorganisms or eggs of small and large organisms are also transported to foreign countries. Therefore, the destruction of the ecosystem caused as a result of organism species which do not originally inhabit a sea area replacing existing organism species is getting serious.

Against this background, a diplomatic conference of the International Maritime Organization (IMO) has adopted an obligation to conduct regular inspections on ballast water treatment equipment and the like, and this obligation is applied to ships constructed after 2009.

Moreover, the discharge standard (G8) set forth in Regulation D-2 of the Convention for the Control and Management of Ships' Ballast Water and Sediments (hereinafter referred to as the Convention) is as follows: plankton with a size of 10 to 50 μm must be 10 cells/ml, plankton with a size of 50 μm or more must be 10 cells/m³, Escherichia coli with a size of 0.5 to 3 μm must be 250 cfu/100 ml, Vibrio cholerae with a size of 0.5 to 3 μm must be 1 cfu/100 ml, and Enterococcus with a size of 0.5 to 3 μm must be 100 cfu/100 ml.

Furthermore, according to the Procedure for approval of ballast water management systems that make use of active substances (G9), which was adopted on Jul. 22, 2005, the objective of the Procedure is to determine the acceptability of active substances and preparations containing one or more active substances and their application in ballast water management systems concerning ship safety, human health, and the aquatic environment. According to G9, an active substance means a substance or organism, including a virus or a fungus that has a general or specific action on or against harmful aquatic organisms and pathogens, and the Procedure requires toxicity testing for verification.

Against this backdrop, extremely strict sterilization or bacterial eradication is required to meet the requirements of G8 and G9.

As the ballast water sterilization/bacterial eradication technology, a technique described in Patent Document 1 is conventionally known as an ozone-based chemical method.

Patent Document 1 proposes a technique of performing sterilization by injecting ozone into ballast water in conjunction with an injection of steam while reducing ozone usage by turning the ozone into microscopic bubbles and thereby promoting the generation of hydroxyl radicals.

However, the reduction of ozone usage has its limit. As a result, research is rapidly going on to adopt membrane treatment.

Many gel-like substances of biological origin exist in ballast water (seawater), and, when the ballast water is subjected to membrane treatment by using a membrane module, these substances may accumulate on the membrane surface in prolonged operation. The problem is that these gel-like substances firmly attach to the membrane surface, and are difficult to remove even when the membrane is backwashed.

Moreover, since ions of mineral origin are present in high concentrations in the ballast water (seawater), when the ballast water is subjected to membrane treatment by using a membrane module, scale may be generated on the membrane surface in prolonged operation. When the scale is generated on the membrane surface, there is a danger that the membrane gets clogged and damaged. Furthermore, the problem is that, when the scale takes in an organic substance and grows into a firm lump, such a lump is difficult to remove even when the membrane is backwashed.

Therefore, in the membrane treatment method, anti-fouling measures become important to prolong the membrane treatment time. As the anti-fouling measures at the time of membrane treatment, a technique of taking measures against fouling by utilizing the expansion of bubbles caused by a reduction of pressure is disclosed in Patent Document 2.

In addition to the aforementioned technology, membrane cleaning is generally adopted as a measure to prolong the membrane treatment time. In Patent Document 3, a technique of performing membrane cleaning by using an enzyme and a technique of performing membrane cleaning by using an enzyme and an oxidizer in combination are disclosed. In Patent Document 4, a technique of performing membrane cleaning by using ethylenediaminetetraacetic acid tetrasodium tetrahydrate is disclosed.

Patent Document 1: JP-A-2004-160437

Patent Document 2: JP-A-2003-265935

Patent Document 3: JP-A-3-133947

Patent Document 4: JP-A-11-319518

### DISCLOSURE OF INVENTION

### Problem to be Solved by the Invention

The technique described in Patent Document 2 has a drawback in that it requires a depressurizing means to depressurize a tank filled with membrane modules, and the facilities therefor become expensive.

The technique described in Patent Document 3 has a drawback in that it produces an inadequate membrane cleaning effect because a fouling substance (a gel-like substance) attached to the membrane is not easily removed by using an enzyme alone. Moreover, the problem is that the cleaning effect by the combination use of an enzyme and an oxidizer can be expected only for a fouling substance resulting from microbial viscosity, and the effect cannot be expected at all for an adhesion factor resulting from a substance itself, such as protein, lipid, or carbohydrate. Furthermore, the technique has little effect on mineral fouling substances.

The technique described in Patent Document 4 has an effect on a fouling substance of mineral origin, but has little effect on a fouling substance derived from a gel-like substance.

Therefore, an object of the present invention is to provide a method for treating ballast water with a membrane, which can reliably remove a fouling substance derived from a gel-like substance and a fouling substance of mineral origin, where the fouling substances attach to the membrane, by separating or breaking down the fouling substances, in order to maintain the membrane flux for long periods.

Other objects of the present invention will become apparent from the following description.

### Means for Solving Problem

The above problem is solved by the invention set forth below.

The invention according to claim 1 is a method for treating ballast water with a membrane, the method provided with, in or on a hull of a ship, a membrane treatment equipment that separates a microorganism with a size equal to or greater than a predetermined size, wherein a fouling substance attached to the surface of the membrane is dissolved, broken down, or removed by using a cleaning fluid containing a peroxide.

The invention according to claim 2 is the method for treating ballast water with a membrane according to claim 1, wherein the peroxide is at least one selected from hydrogen peroxide, hypochlorous acid, and ozone water.

The invention according to claim 3 is the method for treating ballast water with a membrane according to claim 2, wherein the peroxide is hydrogen peroxide, and the concentration of the hydrogen peroxide in the cleaning fluid is 1.0 to 20 wt %.

The invention according to claim 4 is the method for treating ballast water with a membrane according to any one of claims 1 to 3, wherein the cleaning fluid is brought into contact with the membrane in a resting state for a predetermined time, and then the cleaning fluid is discharged.

The invention according to claim 5 is the method for treating ballast water with a membrane according to any one of claims 1 to 4, wherein the cleaning fluid is brought into contact with the membrane in a resting state for a predetermined time, the cleaning fluid is then discharged, and then the discharged cleaning fluid is stored in a heating tank and is subjected to heating treatment.

The invention according to claim 6 is the method for treating ballast water with a membrane according to claim 5, wherein the heating treatment in the heating tank is performed by an existing heat source, such as a main engine cooling system or a boiler, installed in the ship while the ship is at sea.

### Effect of the Invention

According to the present invention, it is possible to provide a method for treating ballast water with a membrane, which can reliably remove a fouling substance derived from a gel-like substance and a fouling substance of mineral origin, where the fouling substances attach to the membrane, by separating or breaking down the fouling substances, in order to maintain the membrane flux for long periods.

### BRIEF DESCRIPTION OF DRAWINGS

FIG. 1 is an explanatory diagram showing an example of equipment performing a method for treating ballast water with a membrane in accordance with the present invention.

### EXPLANATIONS OF LETTERS OR NUMERALS

1: membrane treatment equipment
100: membrane equipment body
101: membrane
102: water collecting part
2: pump
3: circulating tank
4: treated water tank
5: cleaning fluid tank
6: pump
7: heating tank
8: pump
9: heating apparatus

### BEST MODE FOR CARRYING OUT THE INVENTION

Hereinafter, an embodiment of the present invention will be explained by using the drawing.

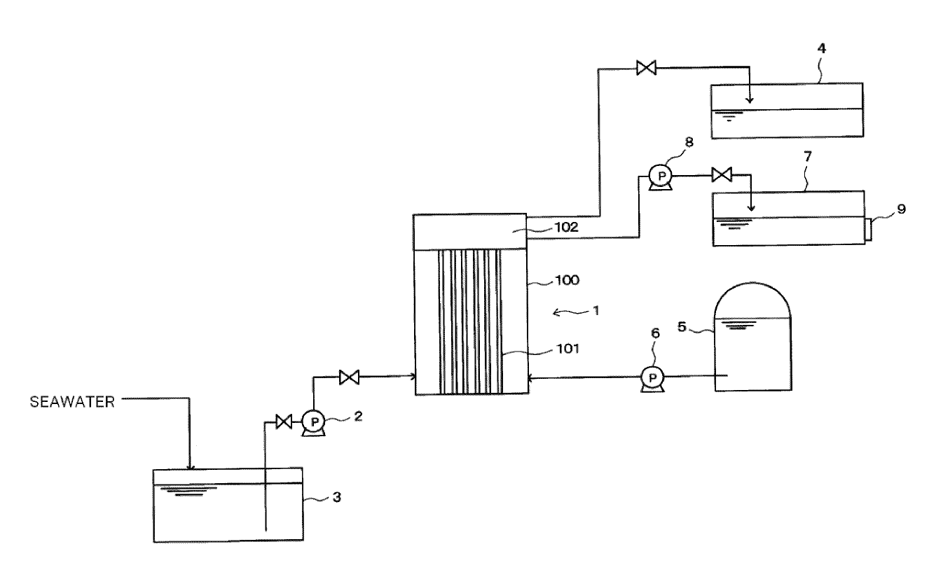

FIG. 1 is an explanatory diagram showing an example of equipment performing a method for treating ballast water with a membrane in accordance with the present invention. In this drawing, 1 denotes membrane treatment equipment installed in or on a hull of a ship, and the membrane treatment equipment is schematically shown.

100 denotes a membrane equipment body, and 101 denotes a membrane. As a membrane, a membrane or filter cloth that meets the above-mentioned standard set forth in G8 (plankton with a size of 10 to 50 μm must be reduced to 10 cells/ml, plankton with a size of 50 μm or more must be reduced to 10 cells/m³, Escherichia coli with a size of 0.5 to 3 μm must be reduced to 250 cfu/100 ml, Vibrio cholerae with a size of 0.5 to 3 μm must be reduced to 1 cfu/100 ml, and Enterococcus with a size of 0.5 to 3 μm must be reduced to 100 cfu/100 ml) can be used. For example, a microfiltration membrane (abbreviated as an MF membrane) can separate particles, microorganisms, and bacterial bodies (plankton, Escherichia coli, Vibrio cholerae, and Enterococcus) which are greater than 0.1 μm. An ultrafiltration membrane (abbreviated as a UF membrane) can separate particles, microorganisms, and bacterial bodies (plankton, Escherichia coli, Vibrio cholerae, and Enterococcus) which are in the range of 2 nm to 0.1 μm. A nanofiltration membrane (abbreviated as an NF membrane) can separate particles, microorganisms, and bacterial bodies (plankton, Escherichia coli, Vibrio cholerae, and Enterococcus) which are smaller than 2 nm. Therefore, in order to achieve the object of the present invention, the membrane simply has to have the function of blocking plankton, Escherichia coli, Vibrio cholerae, and Enterococcus in the range of 0.1 to 50 μm, and it is preferable that the membrane be a microfiltration membrane or filter cloth having the function of blocking particles, microorganisms, and bacterial bodies which are greater than 0.1 μm.

In an example shown in the drawing, a plurality of tubular membranes are provided in the membrane equipment body 100, and seawater is introduced from outside the membrane and is filtered through the membrane, whereby treated water is obtained. Incidentally, although the example shown in the drawing is illustrated with a tubular membrane, the configuration using a pleated membrane or a spiral membrane is the same as that described above.

That is, seawater in a circulating tank 3 is supplied to the equipment body 100 with a pump 2. Pressure is applied to the supplied seawater in the body 100, and the seawater is filtered through the membrane by that pressure. The filtered water is conveyed to a ballast tank 4 via a water collecting part 102.

When membrane treatment is performed continuously for a long time, a fouling substance derived from a gel-like substance and a fouling substance of mineral origin that are contained in the seawater attach to the membrane surface, causing a decline in flux. This makes it impossible to continue filtration.

In the present invention, to dissolve, break down, or remove the attached fouling substance derived from a gel-like substance and the attached fouling substance of mineral origin, the membrane surface is cleaned with a cleaning fluid containing a peroxide (for example, a cleaning fluid containing hydrogen peroxide). That is, in the present invention, the membrane surface may be cleaned by dissolving, breaking down, or removing the fouling substances. The cleaning fluid may be supplied by any method as long as the cleaning fluid can make contact with the fouling substances attached to the membrane surface. For example, any one of an immersion method, a spraying method, and the like, may be adopted; however, it is preferable to adopt an immersion method.

Cleaning with the above-described cleaning fluid is usually performed after stopping the passage of the seawater through the membrane equipment body 100.

The cleaning fluid containing hydrogen peroxide and being stored in a cleaning fluid tank 5 is supplied to the membrane equipment body 100 with a pump 6. The cleaning fluid used for cleaning for a predetermined time and then discharged is stored in a heating tank 7 with a pump 8. Then, the heating tank 7 is heated by a heating apparatus 9 using an existing heat source installed in the hull to break down the remaining hydrogen peroxide. By doing so, it is possible to render the discharged cleaning fluid harmless.

In the present invention, it is preferable that a peroxide contained in the cleaning fluid be at least one selected from hydrogen peroxide, hypochlorous acid, and ozone, and it is more preferable that the peroxide be hydrogen peroxide.

It is preferable that the concentration of hydrogen peroxide in the cleaning fluid be 1.0 to 20 wt %. The above range is preferable because a marked effect cannot be obtained when the concentration is less than 1.0 wt % and too much hydrogen peroxide is left when the concentration is more than 20 wt %.

Examples of a compound that can be added to the cleaning fluid of the present invention are peracetic acid, citric acid, and the like.

### EXAMPLES

Hereinafter, the present invention will be explained by way of examples; however, the present invention is not limited to the examples described below.

### Example 1

Seawater was filtered through a membrane by using membrane treatment equipment (microfiltration membrane: model number BW-40BN; flux 10 m/day). The concentrations of microorganisms and bacteria in the seawater and filtered water were measured. The results are shown in Table 1.

TABLE 1

| | Raw water | Filtered water |
|---|---|---|
| Plankton with a | 100 to 300 cells/ml | ND |
| size of 10 to 50 μm | | |
| Plankton with a | 150 to 300 cells/m³ | ND |
| size of 50 μm or more | | |
| Escherichia coli with a | 1000 to 5000 cfu/100 ml | ND |
| size of 0.5 to 3 μm | | |
| Vibrio cholerae with a | 10 cfu/100 ml | ND |
| size of 0.5 to 3 μm | | |
| Enterococcus with a | 1000 to 2000 cfu/100 ml | ND |
| size of 0.5 to 3 μm | | |

ND: not detectable

### Example 2

In Example 1, a change in flux was checked, and, when the flux was reduced to 30% of that at the start of filtration operation, membrane filtration was stopped. Then, cleaning was performed by using a cleaning fluid. The concentration of hydrogen peroxide in the cleaning fluid was 3 wt %.

After the cleaning, the flux was measured, and was found to have restored to a flux equal to the flux at the start of operation.

### Comparative Example 1

In Example 2, membrane cleaning was performed by using a cleaning fluid containing the following enzymes. The temperature of the enzyme cleaning fluid was adjusted to 30° C. As a result, the flux was found to have restored to only 70% of the flux at the start of operation.

<Enzymes>

Cellulase

Lipase

Serine protease

### Example 3

In Example 2, the cleaning fluid discharged after being used for membrane cleaning was heated at 50° C. for ten hours. After heating, the concentration of hydrogen peroxide, which had been 0.1 wt % immediately after the completion of cleaning, was found not to be detectable (ND), and the discharged cleaning fluid could be rendered harmless.

1. A method for treating ballast water with a membrane, the method provided with, in or on a hull of a ship, the membrane treatment equipment that separates a microorganism with a size equal to or greater than a predetermined size, wherein
a fouling substance attached to a surface of the membrane is dissolved, broken down, or removed by using a cleaning fluid containing a peroxide.

2. The method for treating ballast water with a membrane according to claim 1, wherein the peroxide is at least one selected from hydrogen peroxide, hypochlorous acid, and ozone water.

3. The method for treating ballast water with a membrane according to claim 2, wherein the peroxide is hydrogen peroxide, and a concentration of the hydrogen peroxide in the cleaning fluid is 1.0 to 20 wt %.

4. The method for treating ballast water with a membrane according to claim 1, wherein the cleaning fluid is brought into contact with the membrane in a resting state for a predetermined time, and then the cleaning fluid is discharged.

5. The method for treating ballast water with a membrane according to claim 1, wherein the cleaning fluid is brought into contact with the membrane in a resting state for a predetermined time, the cleaning fluid is then discharged, and then the discharged cleaning fluid is stored in a heating tank and is subjected to heating treatment.

6. The method for treating ballast water with a membrane according to claim 1, wherein the heating treatment in the heating tank is performed by an existing heat source, such as a main engine cooling system or a boiler, installed in the ship while the ship is at sea.
